(19) United States
(12) Patent Application Publication
(10) Pub. No.: US 2009/0198843 A1
(43) Pub. Date: Aug. 6, 2009

(54) METHOD AND APPARATUS FOR MONITORING DISPLAY STATUS

(76) Inventors: Peng LIN, San Francisco, CA (US); Lucas Aaron Zaientz, San Mateo, CA (US); David W. Liu, South San Francisco, CA (US)

Correspondence Address: GLENN PATENT GROUP, 3475 EDISON WAY, SUITE L, MENLO PARK, CA, 94025, US

(21) Appl. No.: 12/024,429

(22) Filed: Feb. 1, 2008

(51) Int. Cl. G06F 3/00

(52) U.S. Cl. 710/19

(57) ABSTRACT

The audio input port and output port of a consumer grade display device is used to detect the status of that device. Status information that can be detected includes whether the display is on or off and whether the display is connected to a designated input source.

### BACKGROUND OF THE INVENTION

1. Technical Field

The invention relates to video displays. More particularly, the invention relates to a method and apparatus for monitoring display status.

2. Description of the Prior Art

In a typical digital signage application, such as the place-based network offered by Danoo (see www.danoo.com), a media player device is connected to a display device, such as a television, in a similar way to that in which a VCR or set top box is connected to a television. In a setup where the media player is networked, it is possible for the administrator of the media player device to monitor the status of the media player remotely via its network connection. Such status includes, for example, whether the media player in turned on or off. However, to monitor the status of the display device that is connection to the media player, a commercial grade display is generally required because a computer grade display does not have an interface that allows it to report its status, such as whether it is on or off, and which input port it is using. If a digital signage network is required to use a consumer grade display, then it loses the ability to monitor and report the status of the display device. For purposes of the discussion herein, a consumer or non-commercial display is a display device that does not have a built-in interface to report its operating status, such as its on/off status and a currently selected input port.

In a digital signage network, where revenue is based upon actually displaying advertising, for example, if it is difficult to assess whether or not the display was turned on or off, then it is difficult to assess whether or not a commercial impression was made that justifies billing for such impression. The fact that the media player is responding to the network does not mean that the display has not been turned off, is defective, or is being used to display something else, for example via another of the display's input ports.

It would be advantageous to provide a method and apparatus for monitoring such display status.

### SUMMARY OF THE INVENTION

An embodiment of the invention provides a technique that uses the audio input port and output port of a consumer grade display device to detect the status of that device. Status information that can be detected includes Whether the display is on or off and whether the display is connected to a designated input source.

### BRIEF DESCRIPTION OF THE DRAWINGS

FIG. 1 is a block schematic diagram of an apparatus for monitoring display status according to the invention; and

FIG. 2 is a flow diagram showing a method for monitoring display status according to the invention.

### DETAILED DESCRIPTION OF THE INVENTION

The invention finds application in connection with a system disclosed in Method and Apparatus for Connecting a Network of Electronic Signs, U.S. patent application Ser. No. 11/673,50, filed 9 Feb. 2007, and which is incorporated herein in its entirety by this reference thereto.

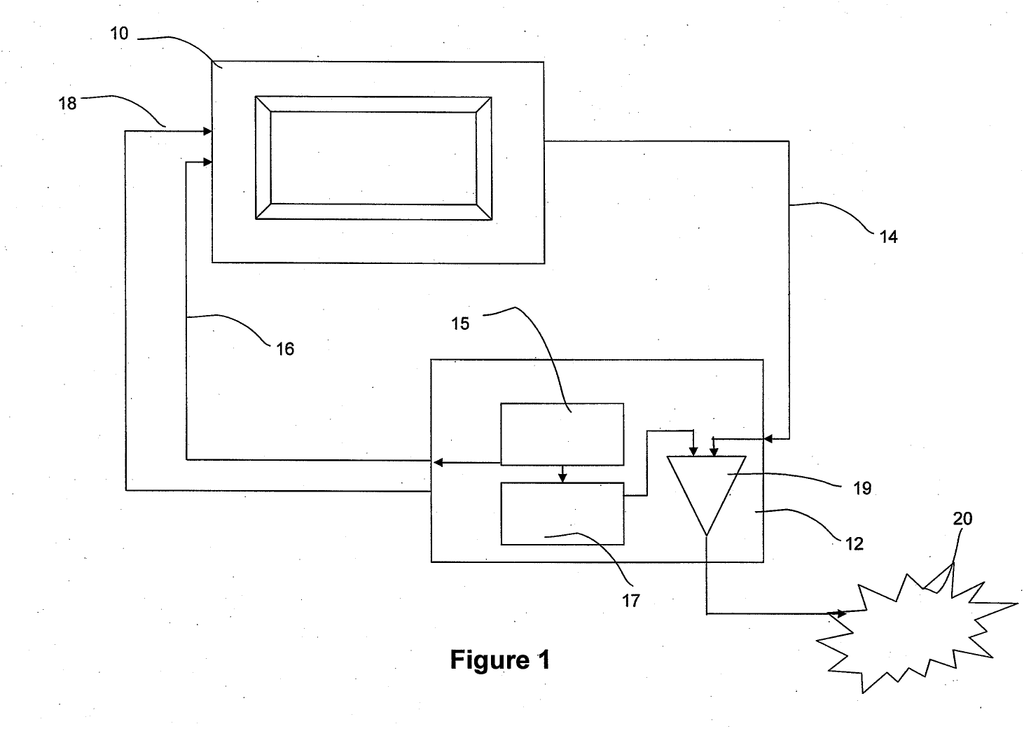

An embodiment of the invention provides a technique that uses the audio input port and output port of a consumer grade display device to detect the status of that device. Status information that can be detected includes whether the display is on or off and whether the display is connected to a designated input source. An embodiment of the invention shown in FIG. 1, requires two audio cables and a software application 15 that runs on the media player device. A first audio cable 16 connects from the audio output port of the media player device 12 to the audio input port of the display device 10. In a typical setup, the audio input port of the display device that is associated with the video input port for the media player device is used. FIG. 1 shows a connection 18, as well, between the video output port of the media player device and the video input port of the display device. In this way, there is a correlation between the video programming that is intended to be displayed and the verification that the display is actually turned on while this video is transmitted and that the input of the display device to which the video is connected is active.

An audio cable 14 connects the audio output port of the display device to the audio input port of the media player device. The audio settings of the display device are configured in such a way that when it receives an audio input signal from the media player device via the audio cable 16, the display device's audio output port transmits the same audio signal via the audio cable 14 to the input of the media player device. Depending upon the model of the display device, this may require that the display device not be muted, or that the audio output of the display device be switched from its speakers to its output port.

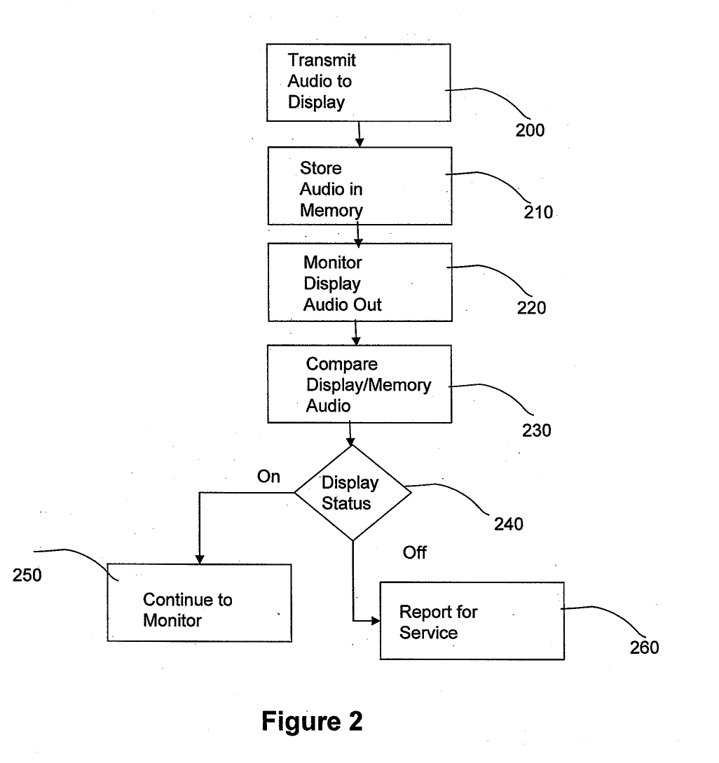

FIG. 2 is a flow diagram showing a method for monitoring display status according to the invention. In this embodiment, the software application both transmits a particular audio signal to the audio input of the display device (200) and records the signal in a memory 17 (210). With a comparator 19, it then compares the recorded audio signal against the signal transmitted from the audio output port of the display device with the signal that was recorded (220). Based upon the result of the comparison (230), it can be determined:
If the signals match (250), in which case the display device is turned on; and the display device is set to display the input source that is associated with the audio output of the media player, as supplied via cable 16.
If the signals do not match (260), in which case the display device is not on; or the display device is on, but it is set to display an input source other than that associated with the audio output of the media player.

The software application then uses the media player device's network connection 20 to transmit the status of the display device to a remote system for monitoring and reporting purposes, e.g. for a service call. Further, rebates based upon display of advertising may be adjusted, based upon the failure of the display to present various advertisements. The software application may also receive instructions over the network connection to implement a status check procedure, or such procedure may be implemented locally, for example on a recurring basis.

In the invention, the video ports can be any of analog and digital ports that can include any known connectors, such as for example RF, RCA, VGA, DVI-1, DVI D, and HDMI connections. Likewise, the audio ports can be any of analog and digital ports that can include any known connectors, such as for example RF, RCA, 3.5 mm, coaxial, and optical connections.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for monitoring display status, comprising:
a media player device connected to an audio input port of a display device, to a video input port of said display device, and to an audio output port of said display device;
a software program stored in said media player device and executing instructions that cause the media player to transmit an audio signal to the audio input port of the display device;
a memory associated with said media player for storing said transmitted audio signal;
a comparator associated with said media player for receiving an audio output signal from said audio output port of said display device and for comparing said received audio signal with the transmitted audio signal stored in said memory and providing an output that is determinative of whether said signals match;
said software program executing instructions that detect status of said display device in response to an output of said comparator and executing instructions that report said detected status to a remote location over a media player device network connection.

2. The apparatus of claim 1, said status comprising any of:
whether the display device is on or off, wherein if said signals match said display device is on and if said signals do not match, or one signal is absent, said device is off; and
whether the display device is connected to a designated input source, wherein if said signals match said display device is connected to said designated input source and if said signals do not match, or one signal is absent, said display device is off and/or said display device is not connected to said designated input source.

3. The apparatus of claim 1, wherein said instructions that report said detected status to a remote location over a media player device network connection establish a service call.

4. The apparatus of claim 1, said software application executing instructions that cause said media player device to receive instructions over said network connection to implement a status check procedure.

5. The apparatus of claim 1, said software application executing instructions that cause said media player device to implement a status check locally, on a recurring basis.

6. A method for monitoring display status, comprising the step of:
connecting a media player device to an audio input port of a display device, to a Video input port of said display device, and to an audio output port of said display device;
storing a software program in said media player device and executing instructions that cause the media player to transmit an audio signal to the audio input port of the display device;
storing said transmitted audio signal in a memory associated with said media player;
receiving an audio output signal from said audio output port of said display device at a comparator associated with said media player, comparing said received audio signal with the transmitted audio signal stored in said memory, and providing an output that is determinative of whether said signals match;
said software program executing instructions that detect status of said display device in response to an output of said comparator and executing instructions that report said detected status to a remote location over a media player device network connection.

7. The method of claim 6, said status comprising any of:
whether the display device is on or off, wherein if said signals match said display device is on and if said signals do not match, or one signal is absent, said device is off; and
whether the display device is connected to a designated input source, wherein if said signals match said display device is connected to said designated input source and if said signals do not match, or one, signal is absent, said display device is off and/or said display device is not connected to said designated input source.

8. The method of claim 6, wherein said instructions that report said detected status to a remote location over a media player device network connection establish a service call.

9. The method of claim 6, said software application executing instructions that cause said media player device to receive instructions over said network connection to implement a status check procedure.

10. The method of claim 6, said software application executing instructions that cause said media player device to implement a status check locally, on a recurring basis.
